(19) United States
(12) Patent Application Publication
(10) Pub. No.: US 2012/0063187 A1
(43) Pub. Date: Mar. 15, 2012

(54) INVERTER DEVICE

(75) Inventors: Masakazu SATO, Anjo (JP); Yoshihiko MINATANI, Anjo (JP); Tatsuya KONDO, Anjo (JP)

(73) Assignee: AISIN AW CO., LTD., Anjo-shi (JP)

(21) Appl. No.: 13/223,765

(22) Filed: Sep. 1, 2011

(30) Foreign Application Priority Data
Sep. 15, 2010 (JP) 2010-206917

(51) Int. Cl. H02M 7/537

(52) U.S. Cl. 363/131

(57) ABSTRACT

An inverter device that converts electric power between a direct current and an alternating current. The inverter is configured with an inverter circuit and a control circuit. The control circuit substrate includes a driver circuit that supplies a control signal for each switching element. The driver circuit is placed so as to overlap a mount region of each switching element in the inverter circuit unit as viewed in a direction perpendicular to a substrate surface of the control circuit substrate. The temperature detection circuit is placed so as to overlap a mount region of the one of the upper arm and the lower min of each of the inverter circuit units. The current detection circuit is placed so as to overlap a mount region of the other of the upper arm and the lower arm of each of the legs in the inverter circuit unit.

### INCORPORATION BY REFERENCE

The disclosure of Japanese Patent Application No. 2010-206917 filed on Sep. 15, 2010 including the specification, drawings and abstract is incorporated herein by reference in its entirety.

### BACKGROUND OF THE INVENTION

The present invention relates to inverter devices that convert electric power between a direct current and an alternating current.

### DESCRIPTION OF THE RELATED ART

In many cases, a motor (a rotating electrical machine) is feedback controlled based on the detection result of a current flowing in the motor. This current is measured by, e.g., a current sensor that obtains a current value by detecting a magnetic flux, which is generated by the current flowing in the motor, using a magnetic detection element such as a Hall element. The magnetic flux is generated around a current path according to the right-hand screw rule. Thus, detection accuracy has been increased by placing a current path (a conductor) through a magnetism collecting core of a magnetic material formed in an annular shape, and collecting by the core a magnetic flux that is generated by a current flowing in the current path. In recent years, however, coreless current sensors using no magnetism collecting core encircling the current path have been used in practical applications in response to demands for reduction in size of the current sensors, reduction in the number of parts, and reduction in cost, etc.

High output motors that are used for motive power in electric cars, hybrid cars, etc. are driven by a high voltage. Power sources that are mounted on such cars are direct current (DC) batteries, etc. Thus, DC power is converted to alternating current (AC) power by an inverter circuit that uses a switching element such as an insulated gate bipolar transistor (IGBT). A signal that drives the inverter circuit, for example, a drive signal that drives the gate of the IGBT, is produced in a control circuit that operates at a much lower voltage than a high-voltage circuit that drives the motor. Thus, a control device of the motor is provided with a driver circuit that supplies the drive signal produced by the control circuit to the IGBT of the inverter circuit.

Japanese Patent Application Publication No. JP-A-2005-94887 discloses a technique with respect to a substrate structure of an electric power converter (an inverter device) that includes such noncontact careless current sensors as described above. This electric power converter is configured to have an inverter substrate and a control circuit substrate, and a current detection circuit including the noncontact current sensors is placed on the control circuit substrate placed on an upper surface of an inverter circuit (No. JP-A-2005-94887: FIG. 3, etc.). Typically, a driver circuit that drives a switching element of an inverter and a temperature detection circuit that detects the temperature of the switching element are also formed on the control circuit substrate. It is more preferable that the driver circuit be located closer to a control terminal (a gate terminal or a base terminal) of the switching element, and it is also more preferable that the temperature detection circuit be located closer to the switching element. Moreover, if each current sensor of the current detection circuit is not appropriately placed with respect to a portion where a current flows, such as a bus bar, the current sensor cannot appropriately sense a magnetic field generated by the current, and thus cannot satisfactorily detect the current. Failure to efficiently arrange these various circuits increases the size of the inverter and the control circuit substrate, which leads to an increase in cost.

### SUMMARY OF THE INVENTION

In view of the above background, it is desired to efficiently place a current detection circuit on a control circuit substrate while suppressing an increase in device size.

In view of the above object, according to a first aspect of the present invention, an inverter device that converts electric power between a direct current and an alternating current includes: an inverter circuit unit that is formed by placing in a planar manner an inverter circuit that has at least one leg having at least one switching element that forms an upper arm that is connected to a positive electrode side, and at least one switching element that forms a lower arm that is connected to a negative electrode side; and a control circuit substrate that is placed parallel to the inverter circuit unit, wherein the control circuit substrate includes a driver circuit that supplies a control signal for each switching element, a temperature detection circuit that detects a temperature of the switching element of one of the upper arm and the lower arm of the at least one leg, and a current detection circuit that detects in a noncontact manner an alternating current flowing in an alternating current power line that is connected to the at least one leg, the driver circuit is placed so as to overlap a mount region of each switching element in the inverter circuit unit as viewed in a direction perpendicular to a substrate surface of the control circuit substrate, the temperature detection circuit is placed so as to overlap a mount region of the one of the upper arm and the lower arm of each of the at least one leg in the inverter circuit unit as viewed in the direction perpendicular to the substrate surface of the control circuit substrate, and the current detection circuit is placed so as to overlap a mount region of the other of the upper arm and the lower arm of each of the at least one leg in the inverter circuit unit as viewed in the direction perpendicular to the substrate surface of the control circuit substrate. Note that the expression “placed so as to overlap as viewed in the perpendicular direction” includes all of the cases where a part of one of elements overlaps a part of the other element, where the entire one element overlaps a part of the other element, and where a part of the one element overlaps the entire other element.

According to the first aspect, in the control circuit substrate, the driver circuit and the temperature detection circuit are placed so as to overlap the mount region of the one of the upper arm and the lower arm, and the driver circuit and the current detection circuit are placed so as to overlap the mount region of the other arm. That is, in the control circuit substrate, the current detection circuit is placed in a region where the temperature detection circuit is not placed and thus there is room. Thus, an increase in substrate area of the control circuit substrate can be suppressed even through the current detection circuit is placed on the control circuit substrate. Moreover, suppressing an increase in substrate area can also suppress an increase in overall size of the inverter device. Thus, according to this configuration, the current detection circuit can be efficiently placed on the control circuit substrate while suppressing an increase in device size.

In the inverter device according to a second aspect of the present invention, the control circuit substrate may further include a control circuit that switching-controls the inverter circuit, and may be configured to have a high-voltage circuit region to which a power supply voltage corresponding to a control terminal drive voltage of the switching element is supplied, and in which the driver circuit and the temperature detection circuit are placed, and a low-voltage circuit region to which a power supply voltage of the control circuit that is a voltage lower than the control terminal drive voltage is supplied, and in which the control circuit and the current detection circuit are placed. Further, the high-voltage circuit region may be formed so as to overlap the mount regions of the upper arm and the lower arm in the inverter circuit unit as viewed in the direction perpendicular to the substrate surface of the control circuit substrate, the low-voltage circuit region may be formed so as to overlap an intermediate region between the mount region of the upper arm and the mount region of the lower arm in the inverter circuit unit as viewed in the direction perpendicular to the substrate surface of the control circuit substrate, and the current detection circuit may be placed in the low-voltage circuit region that is formed so as to protrude from a region that overlaps the intermediate region into a region that overlaps the mount region of the upper arm or the lower arm.

The switching element of each arm of the inverter circuit is driven so as to be switched at a different timing in each arm. Specifically, the switching element is driven by controlling via the driver circuit a potential difference between two terminals, namely a control terminal of the switching element such as a gate or a base and a predetermined reference terminal such as a source or an emitter. A control signal for the switching is produced by the control circuit. However, if a direct current power supply voltage of the inverter circuit is higher than the power supply voltage of the control circuit, the switching element cannot be controlled by a voltage of the control signal generated by the control circuit. Thus, the control signal is supplied to each switching element via the driver circuit to which the power supply voltage corresponding to the control terminal drive voltage of the switching element is supplied. The interconnect distance also decreases as the driver circuit is placed closer to each switching element. Thus, the driver circuit may be placed in the high-voltage circuit region that is formed so as to overlap the mount regions of the upper arm and the lower arm. In many cases, the temperature of the switching element is detected by using as a temperature sensor a thermistor, a diode, etc. that is either contained in the switching element or provided near the switching element. Thus, the temperature detection circuit that detects the temperature of the switching element based on a detection result of the temperature sensor may be also placed closer to the switching element. In the case where the temperature is detected based on the detection result of the temperature sensor that is either contained in the switching element or provided near the switching element, there is no problem even if the temperature detection circuit operates by the same power supply system as the driver circuit. Thus, like the driver circuit, the temperature detection circuit may be placed in the high-voltage circuit region that is formed so as to overlap the mount regions of the upper arm and the lower arm.

On the other hand, the control circuit that generates the control signal needs to supply the control signal to the driver circuit formed so as to overlap the mount regions of the upper arm and the lower arm. Thus, it is preferable that the control circuit be placed in the low-voltage circuit region that is formed so as to overlap the intermediate region between the mount region of the upper arm and the mount region of the lower arm. That is, it is preferable that the control circuit be placed at a position balanced with respect to both arms. The current detection circuit that detects the current without contacting the alternating current power line can easily transmit a detection result to the control circuit without via an insulating circuit or a voltage conversion circuit, if the current detection circuit operates by the same power supply system as the control circuit. Thus, the current detection circuit is placed in the low-voltage circuit region. As described above, however, of those regions overlapping the mount regions of the upper arm and the lower arm, the current detection circuit is placed in the region where the temperature detection circuit is not placed and thus there is room. Accordingly, it is preferable that the low-voltage circuit region be formed not only in the region that overlaps the intermediate region but also in the region that overlaps the mount region of the upper arm or the lower arm. The low-voltage circuit region where the current detection circuit is placed is formed so as to protrude from the region that overlaps the intermediate region into the region that overlaps the mount region of the upper arm or the lower arm. Since the low-voltage circuit region is formed so as to protrude from the region that overlaps the intermediate region, the continuous low-voltage circuit region is formed, whereby the arrangement of the current detection circuit can be efficient.

The temperature detection circuit may be placed so as to overlap the mount region of the lower arm, and the current detection circuit be placed so as to overlap the mount region of the upper arm. When the switching element of the upper arm connected to the positive electrode side of the direct current power supply voltage of the inverter circuit is turned on, the potential of the emitter terminal or the source terminal increases substantially to a positive electrode-side potential. On the other hand, since the switching element of the lower arm is connected to the negative electrode side having a lower voltage, the potential of the emitter terminal or the source terminal is substantially equal to a negative electrode-side potential even when the switching element is turned on. As described above, the driver circuit drives the switching element by controlling the potential difference between the two terminals, namely the control terminal and the reference terminal of the switching element. Thus, the potential of the driver circuit of the upper arm becomes substantially equal to the positive electrode-side potential of the inverter circuit when the switching element is turned on. On the other hand, the potential of the driver circuit of the lower arm remains at about the power supply voltage of the driver circuit even when the switching element is turned on. Thus, the high-voltage circuit region including the driver circuit of the upper arm needs to have a longer insulation distance to another circuit such as the low-voltage circuit region, as compared to the high-voltage circuit region including the driver circuit of the lower arm. In recent years, such current detection circuits that can be implemented by a single IC chip have been used in practical applications. The size of the temperature detection circuit typically is a larger than that of such a current detection circuit. Thus, various circuits can be efficiently arranged on the control circuit substrate by forming the temperature detection circuit in the region that overlaps the mount region of the lower arm where a larger mount area can be secured, and forming the current detection circuit in the region that overlaps the mount region of the upper arm where the mount area is limited.

The inverter circuit of the inverter device according to a fourth aspect of the present invention may be a circuit that converts electric power between a direct current and a three-phase alternating current, and may be formed by three of the legs having the respective upper arms located adjacent to each other and the respective lower arms located adjacent to each other, the alternating current power line may be placed along a direction in which the upper arm and the lower arm of each of the legs are connected together, and a detection portion of the current detection circuit may be placed so as to overlap the alternating current power line as viewed in the direction perpendicular to the substrate surface of the control circuit substrate. Placing the alternating current power line along the direction in which the upper arm and the lower arm are connected together allows the alternating current power line to be placed in or near the mount regions of both the upper arm and the lower arm. In the control circuit substrate, the current detection circuit is placed so as to overlap the mount region of the upper arm or the lower arm. Thus, the detection portion of the current detection circuit can be easily placed so as to overlap the alternating current power line. Accordingly, the detection portion can satisfactorily detect a magnetic field that is generated by the current flowing in the alternating current power line, whereby the current can be accurately detected.

The control circuit substrate of the inverter device according to a fifth aspect of the present invention may include a logical operation circuit that controls the inverter circuit, and a noise suppression filter may be provided at least right before the logical operation circuit on a signal line that transmits a detection result of the current detection circuit to the logical operation circuit. The control circuit substrate is placed parallel to the inverter circuit unit. The inverter circuit unit operates at a higher voltage than the control circuit, and thus a larger amount of current flows in the inverter circuit unit. The high-voltage circuit region that operates at a higher voltage than the control circuit is also formed in the control circuit substrate. Thus, the circuits that are placed in the low-voltage circuit region, such as the control circuit, are in an environment in which the circuits tend to receive noise of a high energy level. The detection result of the current detection circuit is also affected by such noise on the transmission line. However, the noise is suppressed by providing the noise suppression filter right before the logical operation circuit that controls the inverter circuit based on the detection result of the current detection circuit. Thus, the logical operation circuit can control the inverter circuit based on an accurate detection result.

### BRIEF DESCRIPTION OF THE DRAWINGS

FIG. 1 is a block diagram schematically showing a circuit configuration of an inverter device;

FIG. 2 is a block diagram schematically showing a form of signal connection between an inverter circuit unit and a control circuit substrate via an insulating circuit;

FIG. 3 is a block diagram schematically showing a configuration of a power supply generation circuit for supply to driver circuits;

FIG. 4 is an exploded perspective view of an inverter circuit module;

FIG. 5 is an exploded perspective view of a bus bar module;

FIG. 6 is a block diagram schematically showing a configuration of an inverter circuit according to layout of the inverter circuit module;

FIG. 7 is a plan view of the inverter device having the inverter circuit unit attached thereto;

FIG. 8 is a plan view of the inverter device with the control circuit substrate attached to the inverter circuit unit;

FIG. 9 is a diagram illustrating principles of noncontact current detection by a coreless current sensor; and

FIG. 10 is a block diagram schematically showing a configuration of a current detection circuit.

### DETAILED DESCRIPTION OF THE EMBODIMENTS

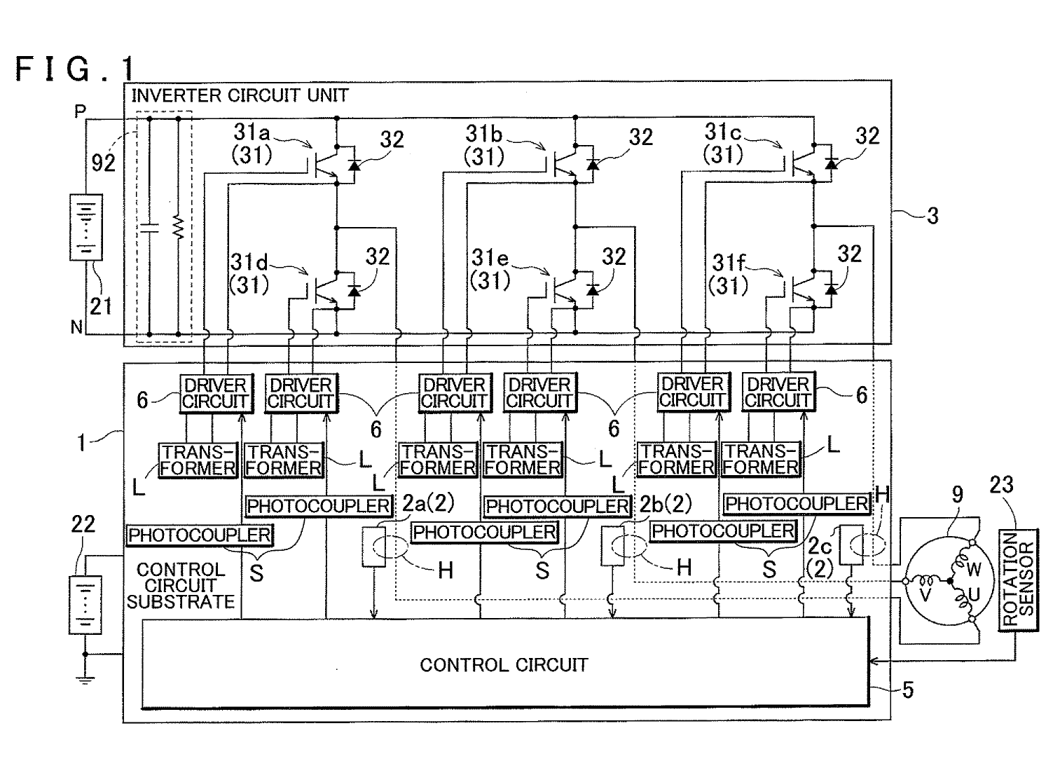

An embodiment of the present invention will be described below using an inverter device in a system that controls a three-phase AC rotating electrical machine serving as a driving source of a vehicle such as a hybrid car and an electric car as an example. This rotating electrical machine is a permanent magnet-embedded synchronous machine, and functions as an electric motor or an electric generator according to the situation. Although the rotating electrical machine is referred to as the “motor” as appropriate in the following description, the term “motor” herein indicates a rotating electrical machine that functions as an electric motor and an electric generator. First, a circuit configuration of the inverter device will be described with reference to FIGS. 1 to 3. As shown in FIG. 1, the inverter device as a motor control device that controls a motor 9 is configured to have a control circuit substrate 1 and an inverter circuit unit 3.

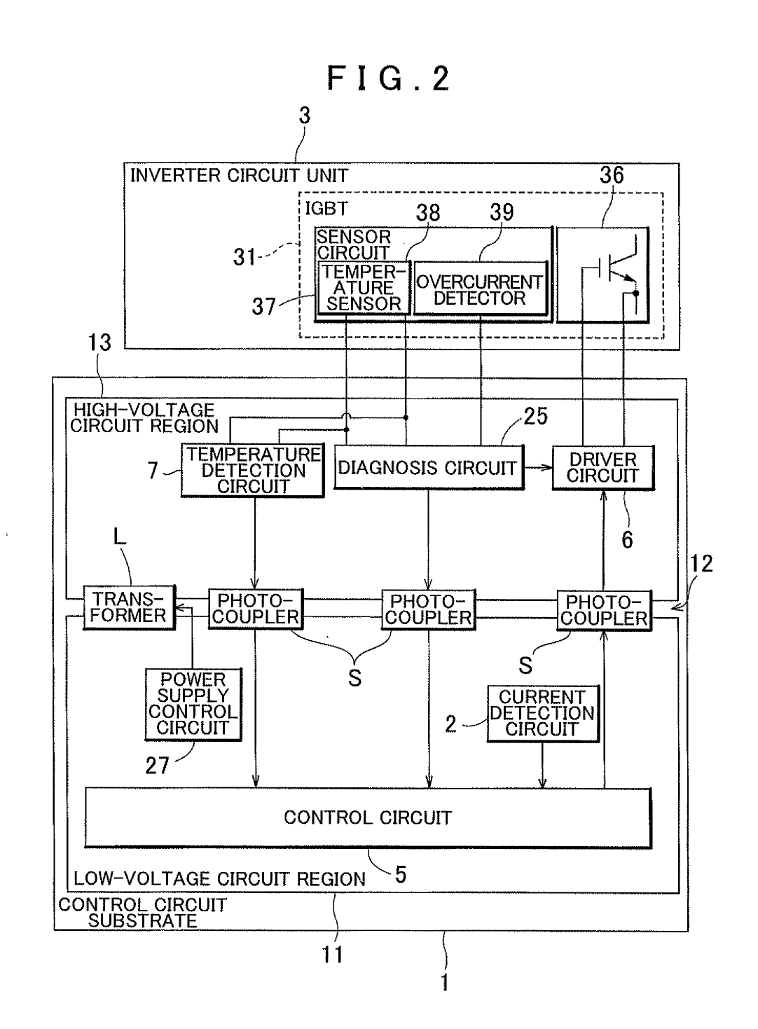

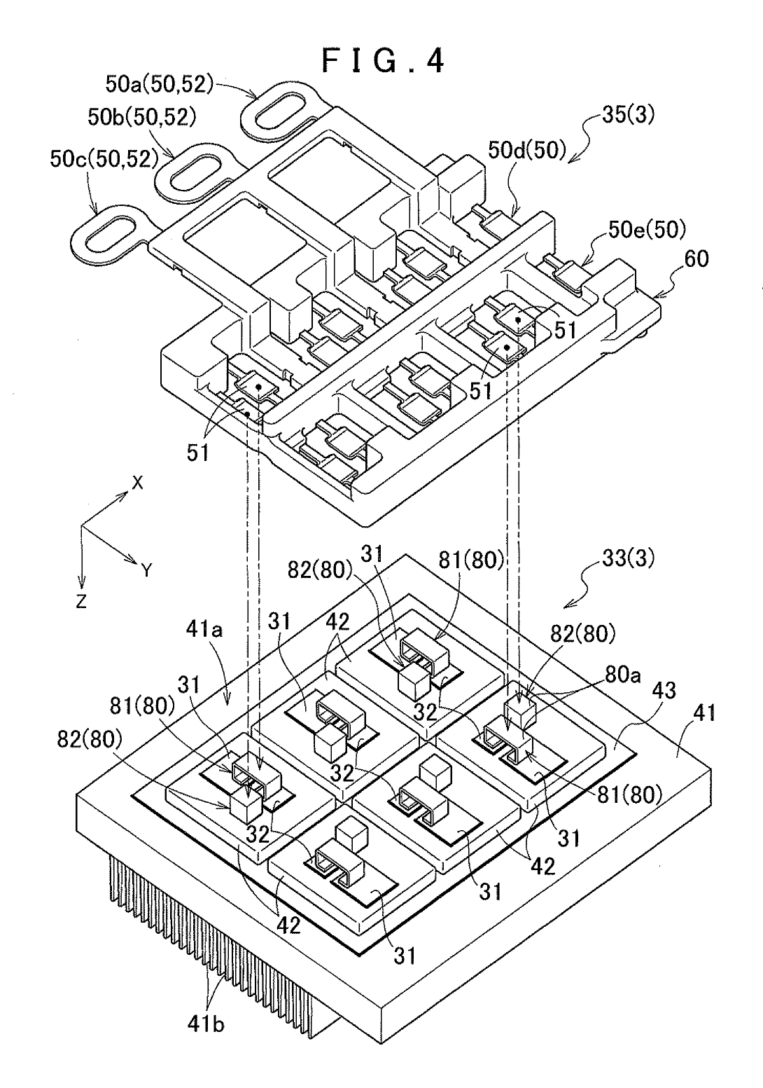

An inverter circuit, which uses IGBTs (insulated gate bipolar transistors) as switching elements and converts electric power between a direct current and a three-phase alternating current, is formed in the inverter circuit unit 3. As shown in FIG. 1, the inverter circuit is configured to include six IGBTs 31 (31a to 31f) and freewheeling diodes 32 respectively connected in parallel to the IGBTs 31. Note that the switching elements are not limited to the IGBTs, and power transistors having various structures, such as bipolar type, field effect type, and MOS type, can be used. As described later with reference to FIG. 4, etc., the inverter circuit has a module structure in the present embodiment. As described later with reference to FIG. 2, etc., sensor circuits 37 for detecting the temperature of the IGBT 31 and an overcurrent are also formed in the inverter circuit.

When the motor 9 performs power running, the inverter circuit unit 3 converts a positive electrode voltage and a negative electrode voltage, which are supplied from a high-voltage battery 21 as a high-voltage power source of, e.g., 100 to 200 V to a three-phase alternating current. The inverter circuit includes a U-phase leg, a V-phase leg, and a W-phase leg corresponding to phases (U-phase, V-phase, and W-phase) of the motor 9. Each leg includes a set of two switching elements formed by the IGBT 31a, 31b, 31c of an upper arm and the IGBT 31d, 31e, 31f of a lower arm, which are connected in series with each other. Specifically, the U-phase leg is formed by the IGBT 31a of the U-phase upper arm and the IGBT 31d of the U-phase lower arm, the V-phase leg is formed by the IGBT 31b of the V-phase upper arm and the IGBT 31e of the V-phase lower arm, and the W-phase leg is formed by the IGBT 31c of the W-phase upper arm and the IGBT 31f of the W-phase lower arm. Motor drive currents of the three phases, namely U-phase, V-phase, and W-phase, are output from connection points between the upper arm and the lower arm of each leg. As described later with reference to FIGS. 4 to 6, etc., these motor drive currents are output to the motor 9 via bus bars 50 (50a, 50b, and 50c) as AC power lines 52. The bus bars 50a, 50b, and 50c are connected to U-phase, V-phase, and W-phase stator coils of the motor 9, respectively. The current flow is opposite when the motor 9 regenerates electric power. Since this is obvious to those skilled in the art, description thereof is omitted.

In FIG. 1, each arm of the inverter circuit is formed by a single IGBT 31. However, due to limitations such as current capacity of the IGBT, a single arm may be formed by arranging a plurality of IGBTs in parallel. In particular, in the case of the inverter circuit having the module structure, the circuit may be formed by mounting a bare chip on a metal base with a ceramic insulating substrate interposed therebetween. In this case, a single arm is sometimes formed by arranging a plurality of bare chips in parallel. Thus, the IGBT (the switching element) of a single arm does not necessarily indicate a single IGBT as shown in FIG. 1, but may indicate all of IGBTs connected in parallel in the single arm.

On the control circuit substrate 1 is formed a control circuit 5 that operates at a voltage much lower than a power supply voltage of the inverter circuit, and at a voltage lower than a gate drive voltage of the IGBTs forming the inverter circuit. A DC voltage of, e.g., about 12 V is supplied from a low-voltage battery 22 as a low-voltage power source to the control circuit substrate 1. Note that the low-voltage power source is not limited to the low-voltage battery 22, but may be formed by a DC-DC converter that steps down the voltage of the high-voltage battery 21, etc.

The control circuit 5 controls the motor 9 according to a command that is obtained from an electronic control unit (ECU), not shown, for controlling operation of the vehicle, etc., via an in-vehicle network such as CAN (controller area network). The control circuit 5 is formed by using a logical operation circuit such as a microcomputer as a core, and produces a drive signal that drives the IGBT 31 of each arm of the inverter circuit in order to control the motor 9. In the present embodiment, since the switching elements are the IGBTs, and control terminals of the IGBTs are gate terminals, the drive signal is herein referred to as the “gate drive signal.”

The control circuit 5 performs feedback control according to the operating state of the motor 9, based on the detection result of a magnetic pole position of the motor 9 obtained by a rotation sensor 23 and the detection result of AC currents obtained by current detection circuits 2. For example, a resolver is used as the rotation sensor 23. In the present embodiment, the current detection circuit 2 is a noncontact current detection circuit that detects the AC current without using a shunt resistor, etc. and without contacting the AC power line 52 such as the bus bar 50. Moreover, the current detection circuit 2 detects the AC current by using a coreless current sensor that detects the AC current without using a core that encircles the bus bar 50. This will be described in detail later. In the present embodiment, one current detection circuit 2a, 2b, 2c is provided for each of the U, V, and W phases. However, since the three-phase AC currents are balanced, and an instantaneous value is zero, only the currents of two phases may be detected.

In particular, in the case where the motor 9 is a drive device of a vehicle, etc., the high-voltage battery 21 has a high voltage of 100 V or more. Each IGBT 31 switches the high voltage based on the pulsed gate drive signal. The potential difference between high and low levels of the gate drive signal of such an IGBT is a voltage that is much higher than an operating voltage (normally 5 V or less) of a common electronic circuit such as the microcomputer that produces the gate drive signal. Thus, the gate drive signal is input to each IGBT 31 after being voltage-converted via a driver circuit 6. At this time, a power supply voltage of the driver circuit 6 is supplied via a transformer L as an insulating circuit, and the gate drive signal is transmitted to the driver circuit 6 via a photocoupler S as an insulating circuit. That is, the high-voltage inverter circuit and the low-voltage control circuit 5 are formed as different power supply systems having no common reference voltage, by interposing the insulating circuits therebetween.

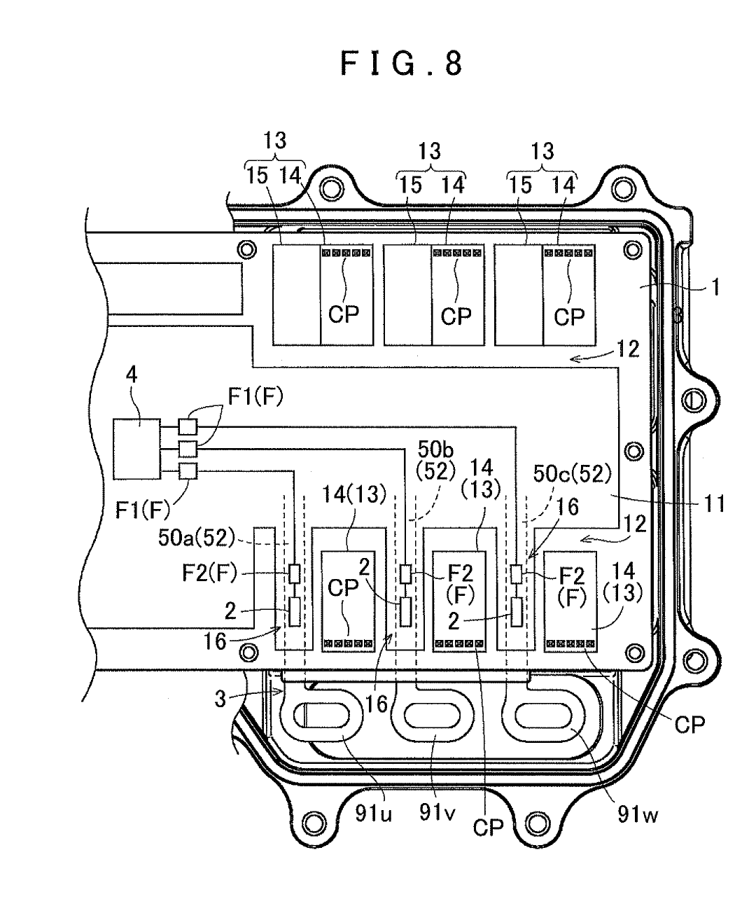

As described later with reference to FIG. 8, the control circuit substrate 1 is configured to have a low-voltage circuit region 11, high-voltage circuit regions 13, and an insulating region 12 provided between the low-voltage circuit region 11 and the high-voltage circuit regions 13. The high-voltage circuit region 13 is a region to which a power supply voltage corresponding to the drive voltage of the gate terminal of the IGBT 31 is supplied via the transformer L, and in which the driver circuit 6 and a temperature detection circuit 7 are placed. The low-voltage circuit region 11 is a region to which a power supply voltage of the control circuit 5 as a voltage lower than the drive voltage of the gate terminal of the IGBT 31 is supplied, and in which the control circuit 5 and the current detection circuits 2 are placed. As shown in FIG. 2, a power supply control circuit 27 that controls the transformer L is also placed in the low-voltage circuit region 11. The transformer L and the photocoupler S have a primary-side (input-side) terminal and a secondary-side (output-side) terminal that are insulated from each other, and are placed on the insulating region 12 with one of the terminals being placed in the low-voltage circuit region 11 and the other terminal being placed in the high-voltage circuit region 13.

As shown in FIG. 2, the gate drive signal produced in the control circuit 5 is wirelessly transmitted to the driver circuit 6 via the photocoupler S. The driver circuit 6 supplies the gate drive signal to the IGBT 31 based on the power supply voltage wirelessly supplied via the transformer L. The IGBT 31 of the present embodiment is a composite element provided with a core part 36 as the IGBT and the sensor circuit 37 for detecting the chip temperature and chip abnormalities such as an overcurrent. In this example, a temperature sensor 38 and an overcurrent detector 39 are shown as the sensor circuit 37 by way of example. The temperature sensor 38 is a thermistor or a diode, and a voltage between terminals, which varies according to the temperature, is detected by the temperature detection circuit 7 and a diagnosis circuit 25. The overcurrent detector 39 detects, e.g., a weak current that is proportional to a high current flowing between a collector and an emitter of the IGBT 31 and that has a ratio of about one one-millionth to one one-hundred thousandth to the high current, according to a voltage at both ends of a shunt resistor, etc. If the current flowing in the IGBT 31 exceeds a predetermined value, the overcurrent detector 39 outputs the detection result to the diagnosis circuit 25.

If the diagnosis circuit 25 determines based on the voltage between the terminals of the temperature sensor 38 that an overheat condition has occurred, or if the diagnosis circuit 25 determines that an overcurrent has been generated due to a short circuit, etc. after receiving the detection result of an abnormality from the overcurrent detector 39, the diagnosis circuit 25 outputs an abnormality diagnosis signal. For example, based on this abnormality diagnosis signal, the driver circuit 6 can control the IGBT 31 to an off state regardless of the state of the gate drive signal received via the photocoupler S. The abnormality diagnosis signal is also transmitted to the control circuit 5 via the photocoupler S. The information that the abnormal condition has occurred is transmitted to the control circuit 5 even though the cause of the abnormality, such as the overheat or the overcurrent, is not transmitted thereto. Thus, the control circuit 5 can perform a process of dealing with the abnormality, such as a process of stopping the motor 9. In the present embodiment, the temperature detection circuit 7 is provided in addition to the diagnosis circuit 25, and the detection result of the temperature detection circuit 7 is transmitted to the control circuit 5 via the photocoupler S. Thus, the control circuit 5 can make a determination based on the detected temperature. It should be understood that the diagnosis circuit 25 and the temperature detection circuit 7 may be formed by the same circuit rather than being formed as separate circuits.

Each of the currents flowing in the three phases flows through the upper and lower arms of the leg of one of the three phases. Thus, the temperature detection circuit 7 that detects the temperature of the IGBT 31 may not be provided corresponding to every arm, and one temperature detection circuit 7 may be provided for each leg. In particular, occurrence of abnormalities including the overheat can be detected if the diagnosis circuit 25 is provided corresponding to each arm. Thus, regarding the temperature detection circuit 7 that detects the temperature of the IGBT 31 in a normal condition, one temperature detection circuit 7 for each leg is enough. In the present embodiment, one temperature detection circuit 7 is provided for each leg of the U, V, and W phases. Specifically, one temperature detection circuit 7 is provided for each leg so as to detect the temperature of the IGBT 31 of one of the arms of the leg. In the present embodiment, the temperature detection circuits 7 are provided each detecting the temperature of the IGBT 31 of the lower arm.

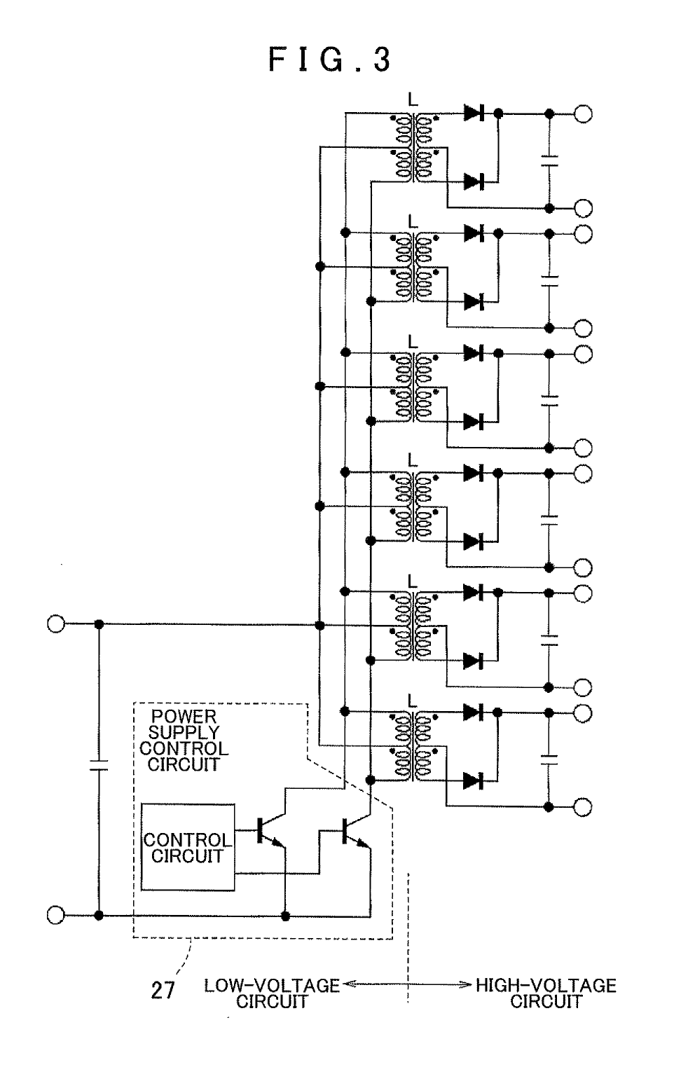

As shown in FIGS. 1 and 3, six transformers L are provided respectively corresponding to the six arms of the inverter circuit. As shown in FIG. 3, the transformers L have the same configuration, and output substantially the same secondary voltage. A primary voltage to the transformer L is a voltage stabilized to a constant voltage in a constant voltage circuit that is included in the control circuit 5 provided in the low-voltage circuit region 11. For example, the voltage of the low-voltage battery 22 having a rated voltage of 12 V varies according to the load. However, the primary voltage to the transformers L is stabilized by, for example, being stepped up to about 15 to 18 volts or being stepped down to about 8 to 10 volts by a step-up regulator, a step-down regulator, etc., respectively, as the constant voltage circuit. The power supply control circuit 27 is formed in the low-voltage circuit region 11 of the control circuit substrate 1, and controls the transformers L as an electric power supply circuit. A push-pull configuration is shown as an example of the power supply control circuit 27 of the present embodiment. Although the six transformers L are provided corresponding to the six arms of the inverter circuit, the power supply control circuit 27 collectively controls all the transformers L. Since the primary voltage of the transformer L has been stabilized as described above, a stable secondary voltage is obtained by the transformation ratio of the transformer L without feeding back the secondary voltage to the primary side.

Thus, the control circuit substrate 1 is configured to have the high-voltage circuit regions 13 and the low-voltage circuit region 11, and various circuits are placed therein. Thus, failure to efficiently arrange the circuits increases the substrate area, which leads to an increased size of the inverter device. In the control circuit substrate 1 of the present embodiment, the current detection circuits 2 are also efficiently placed on the control circuit substrate 1 while suppressing an increase in size. Efficient layout of the control circuit substrate 1 will be described below, and the current detection circuit 2 will also be described in detail. Before describing the efficient layout of the control circuit substrate 1, the structure and layout of the inverter circuit unit 3 will be described with reference to FIGS. 4 to 6.

The inverter circuit unit 3 is configured to have an IGBT module (a switching module) 33 and a bus bar module 35. As shown in FIG. 4, the bus bar module 35 is placed from the upper side of the IGBT module 33 in the drawing so that a part of the bus bar module 35 contacts the IGBT module 33. The bus bar module 35 forms DC current paths (50d, 50e) between the IGBT module 33 and a DC power source (the high-voltage battery 21) formed by a positive electrode P and a negative electrode N, and forms AC current paths (50a, 50b, 50c) between the IGBT module 33 and the motor 9.

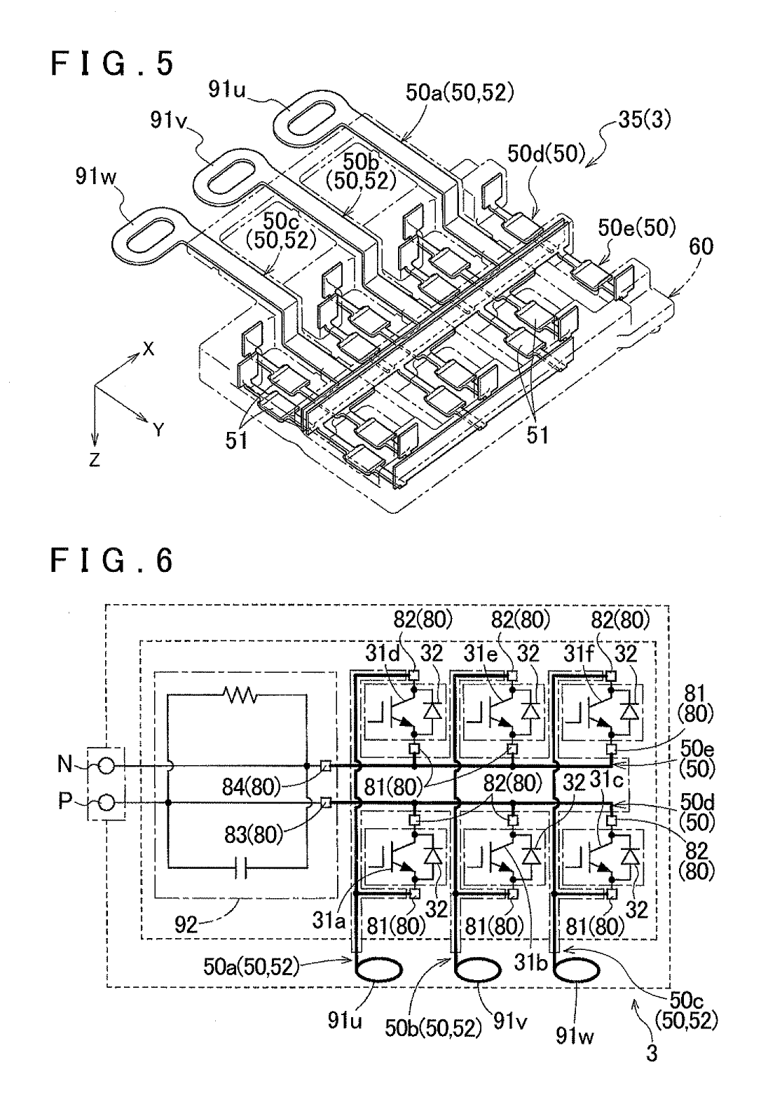

As shown in FIGS. 4 and 5, the bus bar module 35 includes the bus bars 50, and a support body 60 that supports the bus bars 50. The bus bars 50 are made of, e.g., a conductive material that is typically a metal material such as copper, aluminum, etc. The support body 60 is made of an insulating material that is typically various resins. In the present embodiment, the bus bar module 35 includes five bus bars 50, namely a U-phase bus bar 50a, a V-shaped bus bar 50b, a W-phase bus bar 50c, a positive electrode bus bar 50d, and a negative electrode bus bar 50e. These five bus bars 50 are integrally supported by the support body 60. Each bus bar 50 is configured to have a flat plate-shaped junction portion 51 that is in surface contact with a junction face 80a of a corresponding one of electrode members 80 included in the IGBT module 33. Each junction portion 51 is joined to a corresponding one of the electrode members 80 so as to be pressed against the electrode member 80 in the IGBT module 33 in a Z direction that is a predetermined pressing direction.

As shown in FIG. 4, the IGBT module 33 includes a base plate 41, an insulating member 43, and element substrates 42. The base plate 41, the insulating member 43, and the element substrates 42 are stacked together in a direction along the Z direction so as to be in parallel or substantially in parallel with each other. The base plate 41 is a plate-shaped member that serves as a base for placing the insulating member 43 and the element substrates 42. The base plate 41 is made of a metal material such as copper and aluminum, and heat dissipating fins 41b are formed on a lower surface of the base plate 41. An upper surface 41a of the base plate 41 is perpendicular to the Z direction in the drawing.

The element substrates 42 are placed on an upper surface of the insulating member 43 placed on the upper surface 41a of the base plate 41, and the IGBTs 31 and the diodes 32 are mounted on upper surfaces of the element substrates 42. The element substrates 42 are made of, e.g., a conductive material that is typically a metal material such as copper and aluminum, and function also as a heat spreader. As described above, the element substrates 42 are fixed to the base plate 41 via the insulating member 43 having both an electrical insulation property and a thermal conduction property. Thus, heat of the switching elements 31 can be efficiently transmitted to the heat dissipating fins 41b while ensuring electrical insulation between the element substrates 42 and the base plate 41.

In the present embodiment, as shown in FIG. 4, the six element substrates 42 are arranged on the upper surface of the insulating member 43, three in an X direction and two in a Y direction. In the present embodiment, one IGBT 31 and one diode 32 are mounted on the upper surface of each element substrate 42. The IGBT 31 has an emitter electrode and a gate electrode on its upper surface in the drawing, and has a collector electrode in its lower surface in the drawing. The diode 32 has an anode electrode on its upper surface in the drawing, and has a cathode electrode on its lower surface in the drawing. The IGBT 31 is fixed to the element substrate 42 by solder, and the collector electrode on the lower surface is electrically connected to the element substrate 42. The diode 32 is fixed to the element substrate 42 by solder, and the cathode electrode on the lower surface is electrically connected to the element substrate 42. That is, the element substrate 42 has the same potential as the collector electrode of the IGBT 31 and the cathode electrode of the diode 32.

The emitter electrode on the upper surface of the IGBT 31 and the anode electrode on the upper surface of the diode 32 are connected by a first electrode member 81 (the electrode member 80). A second electrode member 82 (the electrode member 80) is placed on the upper surface of the element substrate 42 having both the IGBT 31 and the diode 32 mounted thereon, and is electrically connected to the collector electrode on the lower surface of the IGBT 31 and the cathode electrode on the lower surface of the diode 32 via the element substrate 42. The electrode member 80 is formed by bending a strip-shaped member (a plate-shaped member) having a constant width and made of a conductive material such as copper and aluminum, and the junction face 80a formed by a plane perpendicular to the Z direction is formed in the upper surface in the drawing. The emitter electrode of the IGBT 31 and the anode electrode of the diode 32 are connected to the bus bar 50 via the junction face 80a of the first electrode member 81. The collector electrode of the IGBT 31 and the cathode electrode of the diode 32 are connected to the bus bar 50 via the junction face 80a of the second electrode member 82.

As shown in FIG. 6, a smoothing circuit module 92, which forms the inverter circuit unit 3 together with the IGBT module 33, includes an electrode member 80 (a positive electrode-side electrode member 83) that connects the positive electrode P of the DC power source and the bus bar 50, and an electrode member 80 (a negative electrode-side electrode member 84) for connecting the negative electrode N and the bus bar 50. A junction face 80a is also formed in each of the positive electrode-side electrode member 83 and the negative electrode-side electrode member 84 so as to be parallel to a plane perpendicular to the Z direction. The positive electrode bus bar 50d and the negative electrode bus bars 50e shown in FIGS. 4, 5, and 7 are respectively connected to the junction faces 80a of the positive electrode-side electrode member 83 and the negative electrode-side electrode member 84 so as to be pressed against and in contact with the junction faces 80a.

FIG. 6 shows the inverter circuit corresponding to the arrangement of the IGBTs 31 in the inverter circuit unit 3 shown in FIGS. 4 and 5. The inverter circuit is formed by three legs whose upper arms are adjacent to each other and whose lower arms are adjacent to each other. As shown in FIG. 6, the upper arms are located on the lower side of the drawing, the lower arms are located on the upper side of the drawing, and the positive electrode bus bar 50d and the negative electrode bus bar 50e extend parallel to each other between the upper arms and the lower arms. The bus bars 50a, 50b, and 50c corresponding to the AC power lines 52 of the three phases are placed along a direction in which the upper and lower arms of the leg of each phase are connected together. The bus bars 50a, 50b, and 50c have connection terminals 91u, 91v, and 91w to the motor 9 at their tip ends protruding in the same direction in the inverter circuit unit 3, respectively. The coils of each phase of the motor 9 are respectively connected to the bus bars 50a, 50b, and 50c of each phase via the connection terminals 91u, 91v, and 91w. The smoothing circuit module 92 is provided adjacent to the IGBT module (the switching module) 33 and the bus bar module 35.

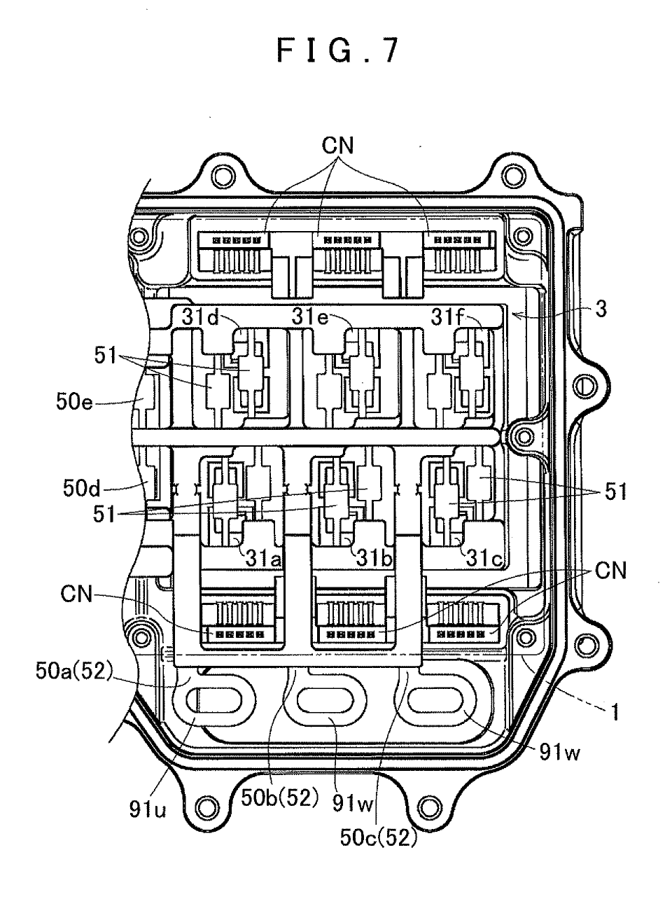

FIG. 7 is a plan view showing the state in which the inverter circuit unit 3 formed by placing the inverter circuit in a planar manner, is attached together with the smoothing circuit module 92 to a housing of the inverter device. FIG. 8 is a plan view showing the state in which the control circuit substrate 1 is placed parallel to the inverter circuit that is placed in a planar manner in the inverter circuit unit 3. In FIG. 8, a part of the bus bar 50a, 50b, 50c of each phase is shown by broken lines as perspective imaginary lines on the side of the connection terminal 91u, 91v, 91w. Reference character “CN” in FIG. 7 represents a connector provided in the inverter circuit unit 3, and the connectors CN are respectively connected to connectors of the control circuit substrate 1 represented by reference character “CP” in FIG. 8. As described above with reference to FIGS. 1 and 2, these connectors CN, CP connect each IGBT 31 of the inverter circuit unit 3 with the driver circuit 6, the temperature detection circuit 7, and the diagnosis circuit 25 that are placed in the high-voltage circuit region 13 of the control circuit substrate 1. As described above, each IGBT 31 has the gate electrode, not shown, on its upper surface in FIG. 4 (the surface on the opposite side from the element substrate 42). The gate drive signal supplied from the control circuit substrate 1 to the inverter circuit unit 3 via the connectors CP and CN are input to the gate electrode and the emitter electrode via an interconnect, not shown.

As shown in FIG. 8, the high-voltage circuit regions 13 and the low-voltage circuit region 11 are formed in the control circuit substrate 1. The high-voltage circuit regions 13 are respectively formed so as to overlap mount regions of the upper and lower arms of each leg in the inverter circuit unit 3, as viewed in a direction perpendicular to the substrate surface of the control circuit substrate 1. Note that the expression “placed so as to overlap as viewed in the perpendicular direction” includes all of the cases where a part of one of elements overlaps a part of the other element, where the entire one element overlaps a part of the other element, and where a part of the one element overlaps the entire other element. Thus, this example includes all of the cases where a part of or the entire of the mount region of each upper arm and each lower arm overlaps a part of or the entire of the high-voltage circuit region 13. The low-voltage circuit region 11 is formed so as to overlap an intermediate region between the mount regions of the upper arms and the mount regions of the lower arms in the inverter circuit unit 3 as viewed in the direction perpendicular to the substrate surface of the control circuit substrate 1. The control circuit 5 and the power supply control circuit 27 are placed in the low-voltage circuit region 11 that is formed so as to overlap the intermediate region.

A driver circuit placement region 14 where the driver circuit 6 is placed is provided in every high-voltage circuit region 13. That is, the driver circuit 6 is placed so as to overlap a mount region of each IGBT 31 in the inverter circuit unit 3 as viewed in the direction perpendicular to the substrate surface of the control circuit substrate 1. A temperature detection circuit placement region 15 where the temperature detection circuit 7 is placed is provided in those high-voltage circuit regions 13 respectively formed so as to overlap the mount regions of one of the upper arms and the lower arms. That is, the temperature detection circuit 7 is placed so as to overlap the mount region of one of the upper arm and the lower arm of each leg in the inverter circuit unit 3 as viewed in the direction perpendicular to the substrate surface of the control circuit substrate 1.

The high-voltage circuit regions 13 are reduced in size in those regions respectively overlapping the mount regions of the other of the upper arms and the lower arms, because the temperature detection circuit 7 is not provided in these regions. The low-voltage circuit region 11, which serves as current detection circuit placement regions 16 where the current detection circuit 2 is placed, is formed in those regions resulting from the reduction in size of these high-voltage circuit regions 13. Specifically, as shown in FIG. 8, in those regions respectively overlapping the mount regions of the arms located on the side where the temperature detection circuit 7 is not placed, the low-voltage circuit region 11 is formed so as to protrude in a pier shape from the region overlapping the intermediate region. This protruding low-voltage circuit region 11 serves as the current detection circuit placement regions 16 where the current detection circuit 2 is placed. More specifically, the low-voltage circuit region 11 is formed so as to overlap the AC power lines 52 as viewed in the direction perpendicular to the substrate surface of the control circuit substrate 1, and the current detection circuits 2 are placed in the low-voltage circuit region 11. Thus, detection portions of the current detection circuits 2 can be placed so as to overlap the AC power lines 52, respectively.

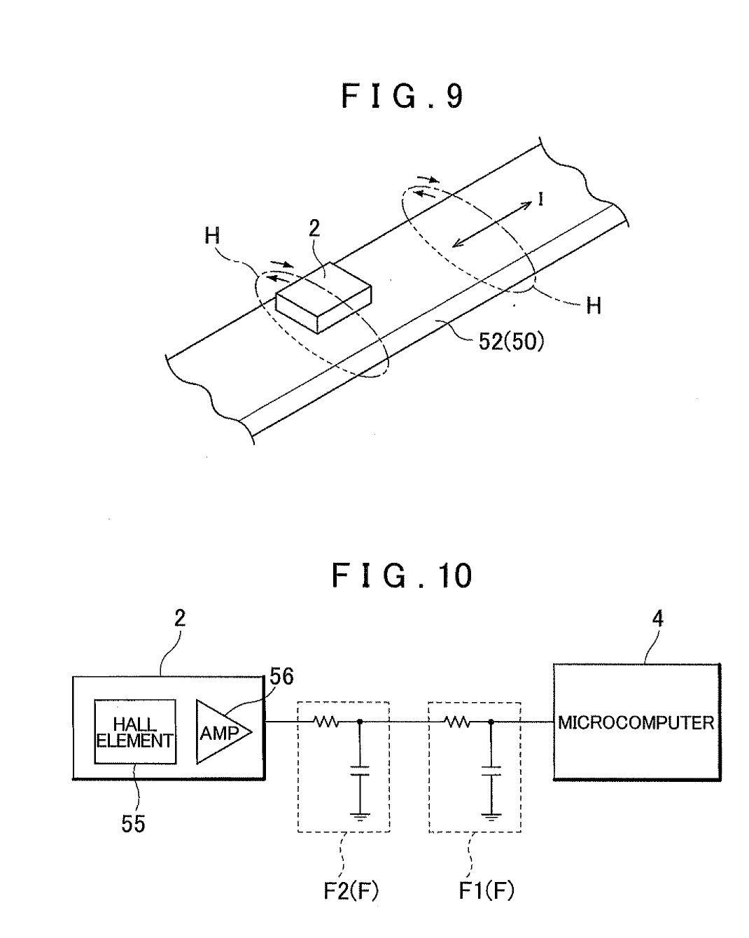

Principles of current detection in the present embodiment will be supplementarily described below. A current value can be obtained without contact to a conductor, by detecting a magnetic flux generated by a current flowing in the conductor using a magnetic detection element such as a Hall element, and the current detection circuit 2 of the present embodiment uses this method. As shown in FIG. 9, the current detection circuit 2 uses a coreless method in which a current I is detected by detecting a magnetic flux H without using a magnetism collecting core that encircles a conductor such as the AC power line 52 and collects the magnetic flux H. As shown in FIG. 10, the current detection circuit 2 of the present embodiment is configured as an integrated circuit (IC) chip in which a Hall element 55 and a buffer amplifier 56 that at least impedance-converts an output of the Hall element 55 are integrated. This IC chip or the Hall element 55 contained in the IC chip corresponds to a detection portion of the present invention. In the case where a core is provided which does not encircle the conductor such as the AC power line 52 and changes the direction of the magnetic flux or converges the magnetic flux to the Hall element 55, such a core also corresponds to the detection portion of the present invention. In the case where the detection portion of the current detection circuit 2 is placed so as to overlap the AC power line 52 as viewed in the direction perpendicular to the substrate surface of the control circuit substrate 1 as shown in FIG. 8, the magnetic flux H that is generated by the current flowing in the AC power line 52 is satisfactorily input to the detection portion, and the current can be accurately detected.

The magnetic flux density of the magnetic flux H that is generated by the current flowing in the AC power line 52 increases as the distance to the AC power line 52 decreases. Thus, it is more preferable that the detection portion of the current detection circuit 2 be located closer to the AC power line 52 because the magnetic flux H can be detected at a higher S/N ratio. Accordingly, it is preferable that the current detection circuit 2 be mounted so that at least the detection portion face the bus bar 50 on the back surface side of the control circuit substrate 1 in FIG. 8, namely on the inverter circuit unit 3 side. However, mounting only a single part on a different surface can increase production cost. Moreover, there may be cases where mounting of the circuit on the inverter circuit unit 3 side is not preferable for other reasons such as thermal resistance of circuit parts. Thus, mounting of the circuit on the back surface is not essential, and the detection portion may be mounted on the upper surface of the control circuit substrate 1 as long as a required magnetic flux H is obtained.

As described above, the control circuit 5, which is mounted on the control circuit substrate 1 and controls the inverter circuit, is configured by using a logical operation circuit such as a microcomputer as a core. As shown in FIG. 8, such a microcomputer 4 is preferably mounted at a position that is balanced with each arm of the inverter circuit. However, the distance of a signal line that transmits the detection result of the current detection circuit 2 from the protruding current detection circuit placement region 16 to the microcomputer 4 (the logical operation circuit) becomes relatively long. Thus, a noise suppression filter F is provided on the signal line as shown in FIGS. 8 and 10.

The control circuit substrate 1 is placed parallel to the inverter circuit unit 3. The inverter circuit unit 3 is switching-controlled and operates at a higher voltage than the control circuit 5, and thus a larger amount of current flows in the inverter circuit unit 3. The high-voltage circuit regions 13 where the circuit that operates at a higher voltage than the control circuit 5 is placed are also formed in the control circuit substrate 1. Thus, the signal line that transmits the detection result of the current detection circuit 2 also receives high-energy noise. Accordingly, providing a noise suppression filter F1 (F) right before the microcomputer 4 (the logical operation circuit) can suppress entry of the noise received on the transmission line into the microcomputer 4. As a result, the microcomputer 4 can use a reliable current detection result. Moreover, further providing a noise suppression filter F2 (F) right after the output of the current detection circuit 2 to the signal line can reduce the influence on the current detection circuit 2 caused by the noise received on the transmission line. As a result, the current detection circuit 2 can stably output a reliable detection result.

### Other Embodiments

In the above embodiment, an example is shown in which the temperature detection circuit 7 is placed so as to overlap the mount region of the lower arm, and the current detection circuit 2 is placed so as to overlap the mount region of the upper arm. In the IGBT 31 of the upper arm connected to the positive electrode P side of the DC power supply voltage of the inverter circuit, the potential of the emitter terminal becomes substantially equal to the potential of the positive electrode P when the IGBT 31 is turned on. The IGBT 31 having such an NPN transistor structure as shown in FIG. 1 is turned on when a predetermined potential difference is applied between the gate terminal and the emitter terminal. Thus, the potential of the low level of the gate drive signal is substantially equal to the potential of the positive electrode P. As a result, the potential on the negative side of the high-voltage circuit region 13 is substantially equal to the potential of the positive electrode P, and the potential on the positive side of the high-voltage circuit region 13 is equal to a potential resulting from applying the secondary-side potential of the transformer L to the positive electrode P. On the other hand, since the IGBT 31 of the lower arm is connected to the negative electrode N side, the potential of the emitter terminal is equal to the potential of the negative electrode N even when the IGBT 31 is turned on. Thus, the potential of the low level of the gate drive signal is substantially equal to the potential of the negative electrode N. The potential on the negative side of the high-voltage circuit region 13 is also substantially equal to the potential of the negative electrode N, and the potential on the positive side of the high-voltage circuit region 13 is equal to the secondary-side potential of the transformer L.

Thus, the high-voltage circuit region 13 including the driver circuit 6 of the upper arm needs to have a longer insulation distance to another circuit such as the low-voltage circuit region 11, as compared to the high-voltage circuit region 13 including the driver circuit 6 of the lower arm. As described above with reference to FIGS. 8 to 10, in recent years, such current detection circuits that can be implemented by a single IC chip have been used in practical applications. In the present embodiment as well, the current detection circuit 2 has such a small-sized circuit configuration. Thus, in the case where the size of the temperature detection circuit 7 is larger than that of such a current detection circuit 2 that can be implemented on a small size, it is preferable that the temperature detection circuit 7 for which a large mount space can be secured be placed so as to overlap the mount region of the lower arm, as described above. Various circuits can thus be efficiently arranged on the control circuit substrate 1.

However, the present invention is not limited to this arrangement, and the temperature detection circuit 7 may be placed so as to overlap the mount region of the upper arm, and the current detection circuit 2 may be placed so as to overlap the mount region of the lower arm. In other words, in the control circuit substrate 1, the driver circuit 6 and the temperature detection circuit 7 may be placed so as to overlap the mount region of one of the upper arm and the lower arm, and the driver circuit 6 and the current detection circuit 2 may be placed so as to overlap the mount region of the other arm. That is, of those regions overlapping the mount regions of the upper arm and the lower arm in the control circuit substrate 1, the current detection circuit 2 is placed in a region where the temperature detection circuit 7 is not placed and thus there is room. Thus, an increase in substrate area of the control circuit substrate 1 can be suppressed even though the current detection circuit 2 is placed on the control circuit substrate 1.

In particular, in the case where the size difference between the current detection circuit 2 and the temperature detection circuit 7 is insignificant, the substrate area of the control circuit substrate 1 is rarely increased regardless of whether the current detection circuit 2 and the temperature detection circuit 7 are placed so as to overlap the upper arm or the lower arm. In the case where the size of the current detection circuit 2 is larger, the temperature detection circuit 7 may be actively placed so as to overlap the mount region of the upper arm, and the current detection circuit 2 may be actively placed so as to overlap the mount region of the lower arm.

In the above embodiment, the inverter device in which the inverter circuit is formed by three legs and converts electric power between a direct current and a three-phase alternating current is described as an example. However, it should be understood that the present invention is not limited to this configuration. The present invention may also be applied to inverter devices that are configured to have at least one leg and that convert electric power between a direct current and an alternating current.

The present invention may be applied to inverter devices that convert electric power between a direct current and an alternating current, and rotating electrical machine control devices that control an AC rotating electrical machine via the inverter device.

What is claimed is:

1. An inverter device that converts electric power between a direct current and an alternating current, comprising:
an inverter circuit unit that is formed by placing in a planar manner an inverter circuit that has at least one leg having at least one switching element that forms an upper arm that is connected to a positive electrode side, and at least one switching element that forms a lower arm that is connected to a negative electrode side; and
a control circuit substrate that is placed parallel to the inverter circuit unit, wherein
the control circuit substrate includes a driver circuit that supplies a control signal for each switching element, a temperature detection circuit that detects a temperature of the switching element of one of the upper arm and the lower arm of the at least one leg, and a current detection circuit that detects in a noncontact manner an alternating current flowing in an alternating current power line that is connected to the at least one leg,
the driver circuit is placed so as to overlap a mount region of each switching element in the inverter circuit unit as viewed in a direction perpendicular to a substrate surface of the control circuit substrate,
the temperature detection circuit is placed so as to overlap a mount region of the one of the upper arm and the lower arm of each of the at least one leg in the inverter circuit unit as viewed in the direction perpendicular to the substrate surface of the control circuit substrate, and
the current detection circuit is placed so as to overlap a mount region of the other of the upper arm and the lower arm of each of the at least one leg in the inverter circuit unit as viewed in the direction perpendicular to the substrate surface of the control circuit substrate.

2. The inverter device according to claim 1, wherein
the control circuit substrate further includes a control circuit that switching-controls the inverter circuit, and is configured to have a high-voltage circuit region to which a power supply voltage corresponding to a control terminal drive voltage of the switching element is supplied, and in which the driver circuit and the temperature detection circuit are placed, and a low-voltage circuit region to which a power supply voltage of the control circuit that is a voltage lower than the control terminal drive voltage is supplied, and in which the control circuit and the current detection circuit are placed,
the high-voltage circuit region is formed so as to overlap the mount regions of the upper arm and the lower arm in the inverter circuit unit as viewed in the direction perpendicular to the substrate surface of the control circuit substrate,
the low-voltage circuit region is formed so as to overlap an intermediate region between the mount region of the upper arm and the mount region of the lower arm in the inverter circuit unit as viewed in the direction perpendicular to the substrate surface of the control circuit substrate, and
the current detection circuit is placed in the low-voltage circuit region that is formed so as to protrude from a region that overlaps the intermediate region into a region that overlaps the mount region of the upper arm or the lower arm.

3. The inverter device according to claim 2, wherein
the temperature detection circuit is placed so as to overlap the mount region of the lower arm, and the current detection circuit is placed so as to overlap the mount region of the upper arm.

4. The inverter device according to claim 3, wherein
the inverter circuit is a circuit that converts electric power between a direct current and a three-phase alternating current, and is formed by three of the legs having the respective upper arms located adjacent to each other and the respective lower arms located adjacent to each other, the alternating current power line is placed along a direction in which the upper arm and the lower arm of each of the legs are connected together, and a detection portion of the current detection circuit is placed so as to overlap the alternating current power line as viewed in the direction perpendicular to the substrate surface of the control circuit substrate.

5. The inverter device according to claim 4, wherein
the control circuit substrate includes a logical operation circuit that controls the inverter circuit, and a noise suppression filter is provided at least right before the logical operation circuit on a signal line that transmits a detection result of the current detection circuit to the logical operation circuit.

6. The inverter device according to claim 1, wherein
the temperature detection circuit is placed so as to overlap the mount region of the lower arm, and the current detection circuit is placed so as to overlap the mount region of the upper arm.

7. The inverter device according to claim 1, wherein
the inverter circuit is a circuit that converts electric power between a direct current and a three-phase alternating current, and is formed by three of the legs having the respective upper arms located adjacent to each other and the respective lower arms located adjacent to each other, the alternating current power line is placed along a direction in which the upper arm and the lower arm of each of the legs are connected together, and a detection portion of the current detection circuit is placed so as to overlap the alternating current power line as viewed in the direction perpendicular to the substrate surface of the control circuit substrate.

8. The inverter device according to claim 1, wherein
the control circuit substrate includes a logical operation circuit that controls the inverter circuit, and a noise suppression filter is provided at least right before the logical operation circuit on a signal line that transmits a detection result of the current detection circuit to the logical operation circuit.

9. The inverter device according to claim 2, wherein
the inverter circuit is a circuit that converts electric power between a direct current and a three-phase alternating current, and is formed by three of the legs having the respective upper arms located adjacent to each other and the respective lower arms located adjacent to each other, the alternating current power line is placed along a direction in which the upper arm and the lower arm of each of the legs are connected together, and a detection portion of the current detection circuit is placed so as to overlap the alternating current power line as viewed in the direction perpendicular to the substrate surface of the control circuit substrate.

10. The inverter device according to claim 9, wherein
the control circuit substrate includes a logical operation circuit that controls the inverter circuit, and a noise suppression filter is provided at least right before the logical operation circuit on a signal line that transmits a detection result of the current detection circuit to the logical operation circuit.

11. The inverter device according to claim 2, wherein
the control circuit substrate includes a logical operation circuit that controls the inverter circuit, and a noise suppression filter is provided at least right before the logical operation circuit on a signal line that transmits a detection result of the current detection circuit to the logical operation circuit.

12. The inverter device according to claim 3, wherein
the control circuit substrate includes a logical operation circuit that controls the inverter circuit, and a noise suppression filter is provided at least right before the logical operation circuit on a signal line that transmits a detection result of the current detection circuit to the logical operation circuit.

13. The inverter device according to claim 6, wherein
the inverter circuit is a circuit that converts electric power between a direct current and a three-phase alternating current, and is formed by three of the legs having the respective upper arms located adjacent to each other and the respective lower arms located adjacent to each other, the alternating current power line is placed along a direction in which the upper arm and the lower arm of each of the legs are connected together, and a detection portion of the current detection circuit is placed so as to overlap the alternating current power line as viewed in the direction perpendicular to the substrate surface of the control circuit substrate.

14. The inverter device according to claim 13, wherein
the control circuit substrate includes a logical operation circuit that controls the inverter circuit, and a noise suppression filter is provided at least right before the logical operation circuit on a signal line that transmits a detection result of the current detection circuit to the logical operation circuit.

15. The inverter device according to claim 6, wherein
the control circuit substrate includes a logical operation circuit that controls the inverter circuit, and a noise suppression filter is provided at least right before the logical operation circuit on a signal line that transmits a detection result of the current detection circuit to the logical operation circuit.

16. The inverter device according to claim 7, wherein
the control circuit substrate includes a logical operation circuit that controls the inverter circuit, and a noise suppression filter is provided at least right before the logical operation circuit on a signal line that transmits a detection result of the current detection circuit to the logical operation circuit.
